(19) United States
(12) Patent Application Publication
(10) Pub. No.: US 2012/0078721 A1
(43) Pub. Date: Mar. 29, 2012

(54) Product Interest Targeting

(75) Inventors: Wisam Dakka, New York, NY (US); Marcel M. Moti Yung, New York, NY (US); Shanmugavelayutham Muthukrishnan, New York, NY (US)

(73) Assignee: GOOGLE INC., Mountain View, CA (US)

(21) Appl. No.: 12/893,105

(22) Filed: Sep. 29, 2010

(51) Int. Cl. G06Q 30/00

(52) U.S. Cl. 705/14.55

(57) ABSTRACT

Methods, systems, and apparatus, including computer programs encoded on a computer storage medium, for facilitating aggregated product requests. In one aspect, a method includes receiving product request data from a plurality of users and determining that an offer request condition has occurred, where the offer request condition specifies a condition under which offers are requested from advertisers. In response to occurrence of the offer request condition, offer request data are provided to advertisers. The offer request data specify a quantity of users from which product request data were received. Offer data are received from advertisers. The offer data specify an offer associated with the particular product and an amount that an advertiser will pay for distribution of the offer. An offer is selected to be provided to the users and presentation data that cause presentation of the selected offer are provided.

### BACKGROUND

This specification relates to data processing and facilitating advertisers' bids to serve offers to groups of buyers wishing to buy products (i.e., products or services), at certain prices.

The Internet provides access to a wide variety of resources. For example, video and/or audio files, as well as web pages for particular subjects or particular news articles, are accessible over the Internet. Access to these resources presents opportunities for retailers to market and sell products to users. For example, a web page can include advertisement slots in which advertisements can be presented. These advertisements slots can be defined in the web page or defined for presentation with a web page, for example, in a pop-up window. Users that select (e.g., click on) an advertisement presented in an advertisement slot can be redirected to a retailer's web page where the user can purchase products from the retailer.

Many users research products prior to their purchase. For example, users may submit one or more search queries to a search engine in an effort to receive information about particular products that they are interested in buying. Additionally, users may interact with other users (e.g., through social networking resources) to obtain information about particular products. Further, users may visit an advertiser's web page to research more information about the particular products.

Advertisements can be targeted to users based on the content of their search queries, content of web pages that the users visit and other information associated with the user (e.g., demographic information). However, some these users to whom advertisements are targeted may not be interested in purchasing the advertised products.

### SUMMARY

In general, one innovative aspect of the subject matter described in this specification can be embodied in methods that include the actions of receiving product request data from a plurality of users, the product request data from each user specifying a particular product and a target price for the particular product; determining that an offer request condition has occurred, the offer request condition specifying a condition under which offers are requested from advertisers; in response to determining that the offer request condition has occurred, providing offer request data to advertisers, the offer request data specifying a quantity of users from which product request data specifying the particular product has been received; receiving offer data from the advertisers, the offer data from each advertiser specifying an offer associated with the particular product and a bid specifying an amount that the advertiser will pay for distribution of the offer to the users from which product request data were received; selecting an offer to provide to the users in response to receipt of the product request data, the offer being selected using the bids received from the advertisers; and providing presentation data that cause presentation of the selected offer to at least one of the users from which product request data was received. Other embodiments of this aspect include corresponding systems, apparatus, and computer programs, configured to perform the actions of the methods, encoded on computer storage devices.

These and other embodiments can each optionally include one or more of the following features. Methods can include the actions receiving interest data from a particular user, the interest data specifying that the particular user has requested more information about the offer presented by the presentation data; and in response to receipt of the interest data, providing additional data about the offer to the particular user.

Providing additional data about the offer can include providing data specifying how the particular user can purchase the particular product according to the offer. Providing data specifying how the particular user can purchase the particular product according to the offer can include providing data that cause presentation of a buy interface through which the product is available to be purchased.

Providing additional data about the offer can include providing data specifying a store location at which the product is available to be purchased. Providing data specifying a store location can include redirecting the particular user to web page associated with the advertiser that is associated with the offer. Providing data specifying a store location can include providing at least one of a phone number, a map, a physical address or driving directions to a store at which the particular product is available to be purchased according to the offer.

Determining that an offer request condition has occurred can include determining that product request data associated with the particular product has been received from at least a threshold quantity of users. Determining that an offer request condition has occurred can further include determining that at least a threshold time period has elapsed since offer request data was last provided to the advertisers.

Providing offer request data to advertisers can include selecting a set of advertisers that are associated with the particular product; generating the offer request data to specify at least two of: a quantity of users from which the request data was received, a statistical measure of the target prices specified by the request data, and a user geographic location associated with the users from which the request data was received; and providing the offer request data to the selected advertisers.

Selecting the set of advertisers comprises selecting a set of advertisers that are associated with a geographic location that is within a threshold distance of the user geographic location. The quantity of users from which the request data was received can be a quantity of users associated with a pre-specified geographic region.

Receiving offer data from the advertisers can include receiving, from each advertiser, offer data specifying at least one of a discount at which the advertiser will sell the particular product to the users or a price at which the advertiser will sell the particular product to the users. Selecting an offer to provide to the users can include selecting the offer based, at least in part, on a discount value specified by the offer.

Methods can further include the actions receiving, from at least one user, a request to distribute a message that informs other users of submission of product request data by the at least one user; generating a message specifying that the at least one user has submitted the product request data; and distributing the message to other users.

Particular embodiments of the subject matter described in this specification can be implemented so as to realize one or more of the following advantages. A data processing apparatus can select and provide online content to users that have submitted product request data indicative of an interest in a particular product. Users to whom online content is targeted can be grouped together by data processing apparatus based on the aggregated product request data that have been received from the users. Online content providers can selectively target online content to a group of users that have expressed an interest in purchasing a particular product at a user specified price. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which each user in a group requests to purchase a product at a target price and receives an offer of the product from an advertiser.

FIG. 2A is a screen shot of an example product request user interface.

FIG. 2B is a screen shot of an example offers user interface.

FIG. 3 is a flow chart of an example process for aggregating product requests from users and providing offers.

FIG. 4 is block diagram of an example computer system that can be used to facilitate aggregated product requests.

Like reference numbers and designations in the various drawings indicate like elements.

### DETAILED DESCRIPTION

Content is targeted to users that have submitted “wishes” to buy a specific product at user specified prices. A “wish” as used throughout this document is a product request that specifies a particular product and a target price at which the user indicates an interest in purchasing the particular product. For example, using computer applications that interact over the Web (e.g., using the user's browser), each user in the set of users can specify particular products and respective prices at which the user is interested in buying the products.

Each user can also send (or post) a message (e.g., by e-mail, through social networking interfaces, blogs, and other online communications medium) to inform other users that the user submitted a wish for the particular products. The message can also suggest that the other users submit a wish for the particular products and/or include a link, or another reference, to an online resource (e.g., a web page, social network interface, or mobile application) with which the other users can submit a wish.

Wishes from the set of users can be aggregated, for example, on a per-product basis. Aggregation can occur globally, according to geo-location, by price range, or by other combinations. Using the aggregated information, an offer request is sent to a set of advertisers (or other online content providers) requesting an offer (e.g., an advertisement including a coupon or other offer) that is responsive to the aggregated wishes and a price that the advertiser will pay for distribution of the offer. An offer, as used throughout this document, is online content that includes an offer to provide a product (or service) according to terms specified by the online content. For example, an advertiser may provide, as an offer, an advertisement that includes a coupon for a 10% discount for a Brand X computer for distribution to users that submitted a wish for a computer. In this example, the advertiser may specify that it will pay $10 cpm (i.e., cost per 1000 impressions) for distribution of the advertisement.

An auction (or another content allocation technique) can be used to select which offer to provide in response to the aggregated wishes. The auction is performed using, in part, the information received from the advertisers, such as the price that the advertiser will pay for distribution of the offer. For example, the auction can be similar to the process used for advertisers who bid on available ad impressions provided by search results pages and/or publisher web pages.

The users who receive (or who are served) the offer may be some or all of the users that submitted a wish specifying the product to which the offer is responsive. For example, the aggregated wishes can be filtered to remove wishes specifying a price that is below a pre-specified price threshold. Users that receive the offer can accept the offer, for example, by following a link in the offer to the advertiser's page and completing a transaction, or visit a brick-and-mortar retail location at which they can purchase the offered product according to the offer (e.g., using the coupon).

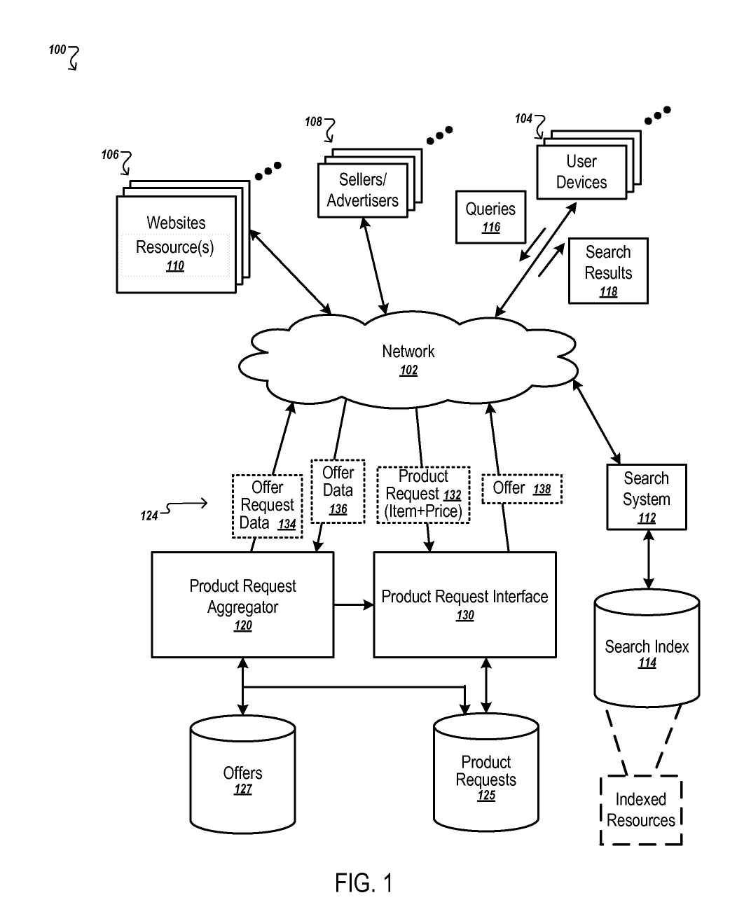

FIG. 1 is a block diagram of an example environment 100 in which online content is targeted using product request data (i.e., data specifying wishes). Products specified by product request data can be products or services. Example products include laptop computers, restaurant dinners, clothing, appliances, and sporting goods. Example services include dry cleaning, carpet cleaning, dog grooming, automobile service (e.g., oil changes, etc.), airline tickets, hotel accommodations, car rentals, and vacation packages.

The environment 100 includes a network 102, such as a local area network (LAN), a wide area network (WAN), the Internet, or a combination thereof over which user devices 104 can access websites 106. Many of these websites 106 include resources 110 that provide information about products offered by sellers/advertisers 108 as well as resources 110 with which users can interact to purchase products, services, or other products provided by the sellers/advertisers 108. For example, as described in more detail below, users can utilize a search system 112 to research particular products. The search system 112 can be a system that performs an Internet-wide search, a search within a social network, or a product search engine that identifies products that match a search query. In turn, the user can request, from a seller's website, a web page that includes user interface elements that enable the user to submit product request data. In some implementations, instead of using the seller's website to submit product request data, the user can use a product request to specify a product and a target price for the product. The target price is a price specified by the user that is considered indicative of a price at which the user has interest in purchasing a particular product. The example environment 100 may include many thousands of user devices 104, websites 106, and sellers/advertisers 108.

The following description refers to a product request user interface as an application that is implemented as code (i.e., a widget) included with a web page or a client-side application. The product request user interface can also be implemented as an application that is implemented in social networking environments, mobile devices (e.g., mobile phones), and or other computing environments.

A website 104 is one or more resources 110 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104. For example, a sellers/advertisers 108 can also be the publisher of a website that provides resources 110 with which a user can interact to purchase products or services from the seller/advertiser 108.

A resource 110 is any data that can be provided over the network 102. A resource 110 is identified by a resource address that is associated with the resource 110. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 104 is an electronic device that is under control of a user and is capable of requesting and receiving resources over the network 102. Example user devices 104 include personal computers, mobile communication devices, and other devices that can send and receive data over the network 102. A user device 104 typically includes a user application, such as a web browser, to facilitate the sending and receiving of data over the network 102. A user device 104 can request resources 110 from a website 106, for example, by entering a URL or other network location that is associated with the resource 110 into a web browser, or by the user clicking on a link that redirects the user device 104 to the URL or other network location that is associated with the resource. In turn, data representing the resource 110 can be provided to the user device 104 for presentation by the user device 104.

To facilitate searching of these resources 110, the environment 100 can include a search system 112 that identifies the resources 110 by crawling and indexing the resources 110 provided by the publishers on the websites 106. Data about the resources 110 can be indexed based on the resource 110 to which the data corresponds. The indexed and, optionally, cached copies of the resources 110 are stored in a search index 114.

User devices 104 can submit search queries 116 to the search system 112 over the network 102. In response, the search system 112 accesses the search index 114 to identify resources 110 that are relevant to the search query 116. The search system 112 identifies the resources 110 in the form of search results 118 and returns the search results 118 to the user devices 106 in search results pages. A search result 118 is data generated by the search system 112 that identifies a resource 110 that is responsive to a particular search query, and includes a link to the resource 110. An example search result 118 can include a web page title, a snippet of text or a portion of an image extracted from the web page, and the URL of the web page. Search results pages can also include one or more advertisement slots in which advertisements can be presented.

Users that are interested in a particular product (e.g., a product or service) and/or users that received a message from another user requesting that the user become interested in the particular product, may research the particular product by submitting one or more search queries to the search system 112 in an effort to identify information that will assist the user in determining whether to purchase the product. For example, a user who is interested in purchasing a laptop computer may submit search queries such as “laptop computer,” “cheap laptop,” or “Brand X laptop.” In response to each of these search queries, the user may be provided search results 118 that have been identified as responsive to the search query. The user can then select one or more of the search results 118 to request presentation of a web page or other resource 110 that is referenced by a URL associated with the search result.

Additionally, the search results pages that are presented to the user in response to these queries may include advertisements that have been selected as responsive to the search queries. For example, in response to the search query “laptop computer,” an advertisement for “Seller A” that sells laptop computers may be presented with the search results page that is provided to the user. If the user selects (i.e., clicks) the advertisement for Seller A, the user's device can be redirected, for example, to a web page provided for Seller A. This web page can include, for example, information about a laptop computer that Seller A sells, a price at which Seller A will sell the laptop computer, and user interface elements that enable the user to specify a quantity of laptop computers that the user will buy, as well as payment information and shipping information required to complete the transaction.

An advertisement that is presented with a search results page can be selected, for example, based on a determination that the search query “matches” a targeting keyword that is used to control distribution of the advertisement. For example, an advertisement for a computer can be associated with the targeting keyword “computer,” such that the advertisement can selected as responsive to the search query “computer.” Some targeting keywords (exact match keywords) require that a search query exactly match the targeting keyword in order for the associated advertisement to be eligible for presentation. Other targeting keywords do not require an exact match between the search query and the targeting keyword. For example, search queries that are stubs, plural forms, past or future tenses, synonyms, or homophones of a targeting keyword can be determined to match the targeting keyword. Additionally, broad match keywords can enable advertisements to be eligible for presentation when search queries are determined to have at least a minimum threshold similarity score (e.g., based on cosine similarity measures or term clustering) relative to the targeting keyword.

Keyword based targeting of online content (e.g., advertisements) based on search queries and/or content of publisher web pages enables advertisers to target advertisements to users that may be interested in products that are related to the search queries (or content). However, it can sometimes be difficult to determine whether a user is interested in purchasing a product based on their search queries, or based on the content of web pages that the user is viewing. For example, a user searching for “Brand X laptops,” may actually be searching for information about technical support for Brand X laptops. It is similarly difficult to determine a price at which the user is interested in purchasing a product based on a search query.

The environment 100 includes a product request aggregator 120 that aggregates product requests received from users and selects, for presentation to the users, online content that is responsive to the product requests. In some implementations, the product request aggregator 120 is a data processing apparatus that is configured to receive product request data that specify product requests from multiple users. Using the product request data, the product request aggregator 120 requests offers from advertisers and amounts that each respective advertiser will pay for distribution of an offer to the users from which product request data were received. As described in more detail below, the product request aggregator 120 can request offers in response to the occurrence of an offer request condition (e.g., a minimum number of product requests being received and/or a threshold quantity of time elapsing). The product request aggregator 120 uses the amounts specified by the advertisers to select one or more offers to be presented to the users from which the product request data were received. In turn, the product request aggregator provides data that cause presentation of the selected offer(s) to the users.

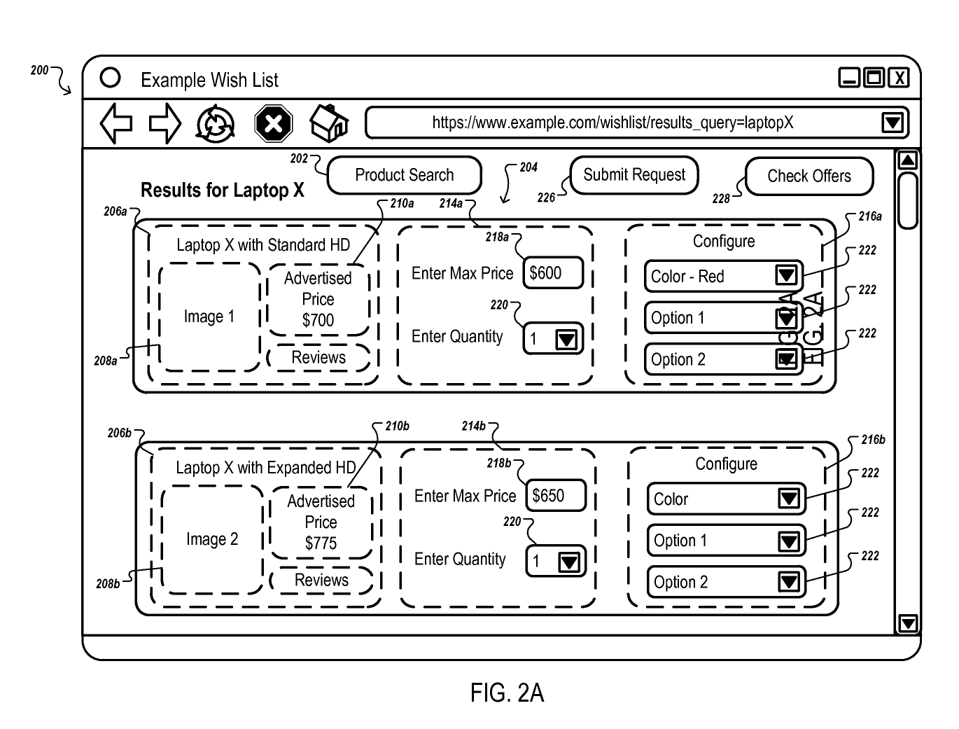

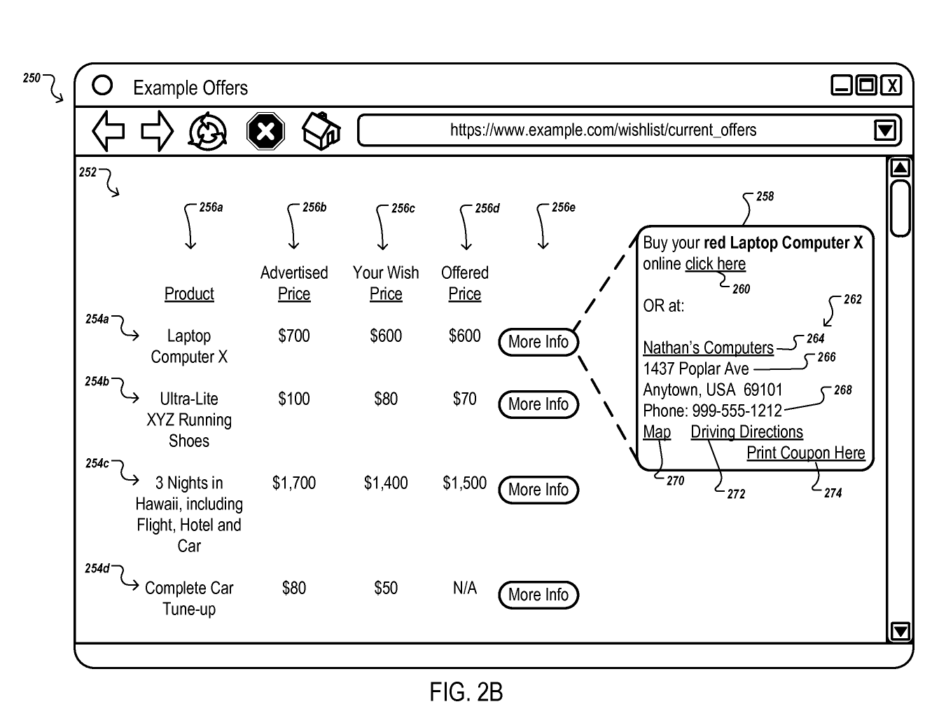

In some implementations, the product request aggregator 120 receives product requests (i.e., product request data) from users through a product request interface 130. As described in more detail with reference to FIG. 2A, the product request interface 130 is a user interface that enables a user to specify particular products and target prices at which the user is interested in purchasing the particular products. The product request interface 130 can be configured to execute on the user's client device 106, for example, accessible from the user's browser. Navigation to the product request interface 130 can occur by clicking on an icon in the user's browser or using a link in a list of “favorites” links or a link that is included in a message received from another user (e.g., through e-mail or a social network interface). In some implementations, social networking web pages, search results pages, or other web pages can include a button or interface by which users can navigate directly to the product request interface 130. In other implementations the product request interface 130 can be presented in response to launching a wish list application that is installed on the user's device.

Using the product request interface 130, the user can specify a particular product that the user is interested in and a target price for the particular product. For example, a user can access the product request interface 130 and specify that the user is interested in purchasing a Brand X Laptop Computer for $600. Assuming that the market price for the Laptop Computer X is $700, the price at which the user is interested in buying the computer is $100 less than the market price. The user's product request can be stored in a product request data store 125, while the product request aggregator continues to receive product requests from other users.

Other users may specify different target prices for the same laptop computer (or similar laptop computers), and as a result, the product request data store 125 can contain a wide range of target prices for the laptop computer. For example, the product requests specify target prices that range from a few offers around $400 up to a large cluster of target prices centered around $600 (e.g., $575 to $625). These product requests may be received and aggregated over a one-hour time period or over a few days, for example. The time over which the product requests are received can be based on an offer request condition. An offer request condition specifies a condition under which offers are requested from advertisers. For example, the offer request condition can be a specified threshold period of time (e.g., 1 hour or 1 day) since offers were requested from advertisers, or a specified quantity of product requests having been received from users.

In some implementations, the product request interface 130 can also enable the user to publicize their interest in a particular product and/or request other users to express interest in the particular product (e.g., by submitting a wish for the product). For example, the product request interface 130 can include a “publicize” element that enables the user to distribute (or post) a message using e-mail, social network communications, blogs, and other methods of communications. Selection of the “publicize” element can cause execution of code that generates the message to include information specifying the particular product that the user expressed interest in purchasing and a message requesting that other users express interest in purchasing the particular product. The user can also be allowed to add personal text prior to distributing the message. Using the “publicize” element, each user can generate additional interest in the products, which can lead to more product requests for the product. Therefore, more users can be provided offers, as described below.

A registration service can be utilized to enable users to utilize the product request interface 130. The registration service can collect demographic information associated with the user, such as the user's name, address, phone number and other account information, some or all of which can be collected using a secure website that may encrypt the user information. The registration service can also serve as the login point by which the user accesses and interacts with the product request interface 130 for selecting products and target prices and viewing offers that are responsive to the product requests. While some information regarding the user and the user's account can be stored by the registration service, other information can be stored on the user's computer, such as in a cookie. As a result, the registration service and/or product request interface can “identify” the user and/or the user's computer, using some of the user information, for example, to streamline the login process.

In some implementations, each user is assigned an anonymous unique identifier that is stored in the product request data store 125. In some implementations, the user identifier can be an identifier generated by the registration service, and this identifier can be known to the product request aggregator 120 and used to identify all of the product requests for a particular user. Using the user identifiers, for example, the product request aggregator 120 can match offers received from advertisers to the users who provided product requests for the corresponding products. The unique identifier can also be associated with demographic information for the user.

FIG. 1 illustrates an example data flow for providing offers responsive to a set of product requests. A product request 132 is submitted by a user 104, for example, using a product request interface 130. The product requests 132, each specifying a particular product and the target price specified by the user, can be stored in the product requests data store 125. Product requests can be received on an ongoing basis, such that hundreds or thousands of offers can be received each day, hour, etc. for the same product (or similar products, e.g., laptop computers). The product request aggregator 120 aggregates the product requests until an offer request condition is satisfied. Then the product request aggregator 120 sends offer request data 134 to a set of advertisers (or other online content providers). Offer data 136 specifying offers are then received from the set of advertisers, and the product request aggregator 120 can stores the offer data in an offers data store 127. Once the offer data have been received, an offer responsive to the product requests is selected and presentation data 138 that cause presentation of the offer are provided to user devices for presentation to the users. For example, the presentation data can be provided to cause presentation of the offers in an offers user interface 250 described below with reference to FIG. 2B.

In some implementations, the offer that is selected as being responsive to a set of product requests is an offer that is associated with a highest selection score (or a set of offers that are associated with a set of the highest N selection scores). A selection score is a score with which online content is selected for distribution. A selection score can be computed, for example, for an offer based on a bid (i.e., an amount that the advertiser will pay for distribution of the offer). The selection score can also be computed based on other factors, such as a quality score associated with an advertiser, a geographic distance between a retail location of the advertiser and the location of the user, and/or a discount value (e.g., relative to a retail price) that is specified by the offer.

FIG. 2A is a screen shot of an example product request user interface 200 with which users can submit product requests. The product request user interface 200 can be implemented, for example, to enable users to specify one or more products that they may be interested in buying at the specified target price. The product request user interface 200 can include a product search element 202 or other controls for identifying products.

The product search element 202 can be a user interface element that enables a user to search for specific products. For example, the product search element can include (or cause presentation of) a text box in which the user can enter one or more words (e.g., “laptop computer x”). In response to submission of the one or more words, the product request user interface 200 can present products in a product display area 204. In this example, the product display area 204 displays information for the Laptop Computer X with a standard hard drive, and one with an expanded memory hard drive. The products that are responsive to the one or more words can be selected in a manner similar to the manner by which products responsive to search queries are selected.

The product request user interface 200 can include product information 206a, 206b for products that are responsive to the one or more words entered by the user as described above (e.g., Laptops X with standard and expanded hard drives, respectively). The product information 206a, 206b can include images of the products 208a, 208b, advertised price elements 210a, 210b and review elements 212a, 212b (e.g., how have other consumers rated or described the products). Each of the advertised price elements 210a and 210b, for example, can represent the current asking price for the corresponding products, such as the online price or the price at which the product is being offered by retail stores. In some implementations, the advertised price elements 210a, 210b displayed can be ranges of prices. In some implementations, the advertised price elements 210a, 210b can be further annotated to identify separate prices or price ranges for online purchases versus store purchases. For online purchases, the advertised price elements 210a, 210b can also indicate shipping costs and sales taxes associated with the products.

The product request user interface 200 can also include price elements 214a, 214b and product configuration elements 216a, 216b that are respectively associated with the product information 206a, 206b. The user can use the price elements 214a, 214b to specify target prices for selected products. The user can use the product configuration elements 216a, 216b to specify the color, size or other aspects of the product of interest. For example, the user may be interested in making an offer on a “red” Laptop X with a standard hard drive.

The price elements 214a, 214b each include a text box 218 in which a user can enter a target price at which the user is interested in buying the product that is described by the product information 206a and 206b. The price elements 214a, 214b also include a quantity element 220 that enable the user to specify a quantity of products that the user may want to buy at the target price entered at the text box 218. The configure elements 216a, 216b each include drop-down option selection boxes 222 that enable a user to customize selected products. Example customization options for laptops can include, for example, software packages that are loaded on the laptop, and/or extended warranties.

Once the user has completed configuring products, the user can submit product request data using a submit request element 226. In response to user selection of the submit request element 226, the user's client device (e.g., the user's browser) can provide the product request data, for example, to the product request aggregator 120 and/or the product requests data store 125 of FIG. 1. As described above, the user can also elect to “publicize” their product request by sending a message to other users by e-mail or through social network communications.

The information in the product requests data store 125 is available to the product request aggregator 120 which, over time, can aggregate the product request data from multiple users who have submitted offers for the same product. For example, the information for any one product may reside in the product request data store 125 until a threshold quantity of requests exist for the same product (or similar products, such as product requests for different brands of computers). In some implementations, the product request data may be shared with advertisers (e.g., with offer request data) at regular time intervals, such as hourly or daily to name a few examples.

Some implementations of the product request user interface 200 include a check offers control 228 that the user can use to check for offers that have been selected in response to the user's product request. The offers may be available for presentation on demand following submission of the product request data (e.g., if many other users are making similar offers on a similar or same product at roughly the same time), or the offers may take several minutes, hours or days to be available for presentation. In some implementations, the product request user interface 200 can include an indicator (not shown) that new offers have been received. Alternatively, a notification (e.g., e-mail, phone call, text message) can be sent to the user informing the user that offers are available for presentation and/or including the offers. Offers can also be presented upon receipt by the user device.

FIG. 2B is a screen shot of an example offers user interface 250 for viewing offers that have been selected based on product requests. The offers user interface 250 includes an offers area 252 that displays offers 254a-254d, listing offers that have been selected for the user. Columns 256a-256e can be used to present information about the offers, including a product name 256a, price information 256b-256d, and “more info” buttons 256e. For example, the product name column 256a can identify the product or service being offered, such as the “Laptop Computer X,” “Ultra-Lite XYZ Running Shoes,” “Three Nights in Hawaii (including Flight, Hotel and Car),” and a “Complete Car Tune-up.” The advertised price column 256b can specify a market price (e.g., $700) for the product. Column 256b can specify the target price specified by the user (e.g., $600) in the product request. Column 256d can specify an offer price (e.g., $600). The offer price may match the user's target price, be higher than the user's target price, or be lower than the user's target price.

In some implementations, the user can request additional information about the offer by selecting the “more info” button in column 256e that corresponds to (e.g., is presented adjacent to) an offer (e.g., one of the offers 254a-254d). Upon selecting any particular “more info” button, for example, an additional information popup 258 can be displayed. For example, the example data in the popup 258 corresponds to the Laptop Computer X entry 254a that can be displayed after the user selects the “more info” button in that entry. Selection of the “more info” button can also redirect the user to a web page at which the information is presented.

The popup 258 can identify a location at which the product can be purchased at the offered price, such as on online websites or a local retail store. In some implementations, the online purchase method can be represented with a buy link 260 (e.g., “click here”) which, when selected, can cause presentation of an online buy interface with which the user can purchase the product. In some implementations, selecting the buy link 260 can result in displaying a web page associated with the advertiser that is associated with the offer, including, for example, fields, controls and other user interface features for purchasing the offered product. In some implementations, selecting the buy link can cause the offers user interface 250 to display another popup by which the user can complete a purchase transaction.

The popup 258 also includes, in this example, store location information 262 which identifies a physical, brick-and-mortar store (e.g., “Example Computers”) at which the product is available to be purchased. In some implementations, the name of the store can also serve as a link 264 that, for example, the user can select to be redirected to a web page that is associated with the store location or with the advertiser that is associated with the offer. The store location information 262 can also include the store's address 266 and one or more phone numbers 268. In some implementations, the user can select a map link 270 to display a map (e.g., that includes the store push-pinned location within a surrounding area) and/or a driving directions link 272 that can provide a popup that lists step-by-step directions for getting from the user's current location to the store. In some implementations, the user's current location can be based on the GPS coordinates of the user's mobile device. In some implementations, the user's current location can be typed in (e.g., in one or more fields accessible from the popup 258) or obtained using location information associated with the user's computer (e.g., based on cookies or the computer's IP address).

The popup 258 can include a coupon link 274 that the user can select to print a coupon or other document related to the offer. For example, the $600 price of the Laptop Computer X purchased at a store may depend on (or include) the use of a coupon that identifies a discount that is either a dollar amount, a percentage discount, or another specified discount amount. Other example discount-related promotions can include free installation, free shipping, and/or additional features.

In some implementations, the offers user interface 250 and/or the popup 258 can provide information for multiple offers of the same product. For example, in this way, the user can be presented with offers for the top three advertisers for Laptop Computers X.

Some implementations of the product request interface 130 can execute on mobile computing devices, such as smart phones, etc. As a result, the layout of the product request user interface 200 the offers user interface 250 may be different for mobile users.

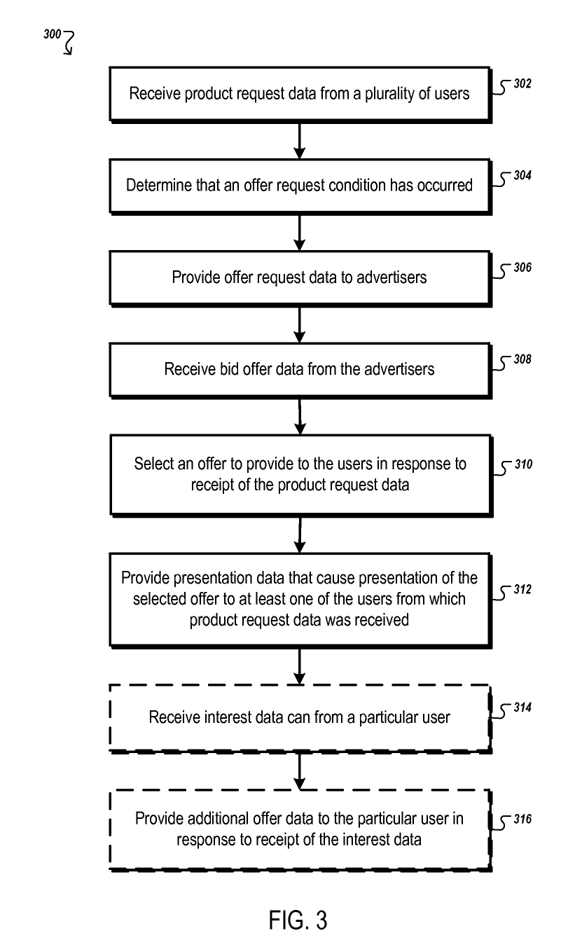

FIG. 3 is a flow chart of an example process 300 for providing offers responsive to product requests. The process 300 is a process by product requests are received from users. When an offer request condition occurs, offer request data are provided to content providers (e.g., advertisers). Offer data are received from the advertisers, and an offer is selected for presentation to the users based on the offer data. In turn, presentation data that cause presentation of the offer are provided to a user device.

The process 300 can be implemented by components within the environment 100, including the product request aggregator 120 and the product request interface 130. The process 300 can also be implemented as instructions stored on computer storage medium such that execution of the instructions by data processing apparatus cause the data processing apparatus to perform the operations of the process 300.

Product request data are received from a plurality of users (302). The product request data from each user specifies a particular product and a target price for the particular product. For example, referring to FIG. 2A, a user can use the product request interface 130 to enter a target price of $600 in the text box 218a for a red Laptop Computer X with a standard hard drive. During the same (or a different) session, the user may also enter a target price of $650 in the text box 218b for a Laptop Computer X with an extended hard drive (e.g., double the number of gigabytes or terabytes of storage as the standard model). Other users may also enter prices for standard Laptop Computers X, each at various price offers (e.g., $640, $660, $450 and 670, respectively). The product request interface 130 can store product requests that are submitted by the users in the product request data store 125.

Product request data may also be received from users that received a request to express interest in the particular product. In some implementations, users that submit a product request can “publicize” their product request by distributing a message informing other users (e.g., social network friends or other online contacts) that they submitted a product request for the particular product. For example, a user that submits a product request for a red Laptop Computer X can send an e-mail message or a social network message informing their online contacts (e.g., users in a “friends list”) that the user submitted the product request.

The message can be at least partially generated by a data processing apparatus in response to receiving the request to publicize. In some implementations, the message is generated to specify details of the product request and/or request that the recipient of the message submit a product request. The message can include, for example, a hypertext link or another reference to a web page or application with which the recipient can submit their product request. The message can be distributed to other users that can, in turn, submit product request data by clicking the link or other reference included in the message.

A determination is made that an offer request condition has occurred (304). The offer request condition specifies a condition under which offers are requested from advertisers. As described above, the offer request condition can be specified as receipt of a threshold quantity of product requests for a particular product (or category of products, such as computers). The threshold values can vary based on the types or categories of products that are being requested. For example, the threshold quantity of requests for some products may have a threshold value of hundreds or thousands, depending on the product. Other product categories, such as all-inclusive vacations, may have a threshold of fewer that one hundred users, for example.

The offer request condition can alternatively (or additionally) include a threshold period of time (e.g., 1 hour or 1 day) elapsing since offer request data was last sent to advertisers. For example, for some product categories (or advertiser categories), offer request data can be sent to advertisers on a daily schedule, such that every 24 hours offer request data specifying product requests received over the last 24-hour period are sent to advertisers. For other product categories (or advertiser categories), the threshold time period can be shorter (e.g., every hour or two, etc.) or longer (e.g., every few days to a week).

The offer request condition can also specify that a threshold quantity of product requests in a certain price range (e.g., within 30% of the retail price) must be received. Further, the offer request condition can specify a threshold number of product requests must be received from a certain geographic area (e.g., Southern California or a specific zip code). The product request aggregator 120, for example, can make the determination that an offer request condition has occurred (i.e., been met).

Offer request data are provided to advertisers (306). In some implementations, the offer request data are provided in response to determining that the offer request condition has occurred. The offer request data specify a quantity of users from which product request data specifying the particular product have been received. The product request aggregator 120, for example, can generate offer requests (e.g., based on information in the product request data store 125 for the product) and provide the offer requests to the advertisers of the product.

The offer request data can specify the quantity of users who have provided product requests for the product and are included in the aggregated set of users represented by the offer request data. This quantity of users can be, for example, the same quantity of users who have provided product requests (i.e., all users that submitted product requests for the particular product), a smaller subset of the users, selected from the entire set, for example, based on price, geo-location or other factors (e.g., user demographics). For example, the quantity of users specified by the offer request data can be less than a total quantity of users from which product requests were received when price filtering is used to remove users that have specified a price that is below a minimum threshold price.

In some implementations, the product request aggregator 120 can generate offer request data that specify at least two attributes of the group of users from which product requests were received. The attributes of the group of users can include: a quantity of users from which the product requests were received, a statistical measure of the target prices specified by the request data, and/or geographic location information associated with the users who provided the product requests. For example, using the geographic location of the users that provided product requests and the target prices, offer request data can be generated that specify geographic locations of the users from which the product requests were received and a median target price that was submitted by the users. Similarly, request data can be generated that specify a quantity of users from which product requests for a particular product were received, a geographical distribution of the users, and a target price distribution associated with the users.

In some implementations, the offer request data can be provided to a subset of available advertisers. For example, if product requests are grouped based on a geographic basis, offer request data can be provided to advertisers that are within a threshold distance of the users' geographic locations (e.g., a 25-mile radius around a central geographic location associated with the users). Geographic locations of advertisers can be represented, for example, by latitude/longitude coordinates, a pre-specified geographic area bounded by a rectangle, polygon, or another shape or curve, or a geographic location of a city, county, region, state, or country.

Offer data are received from the advertisers (308). The offer data from each advertiser specifies an offer associated with the particular product and a bid. The offer can be an advertisement for the particular product that specifies a price and/or a discount at which the advertiser will sell the particular product to the users. For example, the offer data for the Laptop Computer X may be in the form of $100 off the online or store price, or 15% off either price, to name a few examples. In some implementations, the offer data can include an electronic document (e.g., a printable coupon or offer sheet) that can be provided to the user. For example, referring to FIG. 2B, a user can print a discount coupon using the coupon link 274.

The bid specifies an amount that the advertiser will pay for distribution of the offer to the users from which product request data were received. For example, an advertiser may specify a cost-per-click bid, a cpm bid, or a flat price that the advertiser will pay for distribution of the offer in response to the product requests.

An offer is selected to be provided in response to receipt of the product request data (310). The offer is selected using selection scores associated with the offers. The selection scores can be values that are computed, in part, using the bids received from the advertisers, quality scores associated with the advertisers, and/or a magnitude of the discount (e.g., relative to a market price or another baseline price) offered by the advertiser. For example, the selection score can be a product of the bid, the quality score, and/or the magnitude of the discount. Offers can be selected, for example, based on the outcome of an auction, or another selection technique that is performed using the selection scores. In some implementations, multiple offers can be selected in response to a single offer request. For example, offers associated with the highest 3 selection scores can be selected to be provided in response to the product requests.

In some implementations, offers from different advertisers may be provided to users from different geographic regions. For example, users from California may receive an offer from Advertiser A that is also located in California, while users from Atlanta may receive an offer from Advertiser B that is located in Atlanta. In some implementations, other criteria for selecting multiple offers can be used.

Presentation data are provided that cause presentation of the selected offer to at least one of the users from which product request data was received (312). For example, data can be provided that cause presentation of offers in an interface such as the offers user interface 250 described with reference to FIG. 2B.

Interest data can optionally be received from a particular user (314). Interest data are data specifying that the particular user has requested more information about the offer presented by the presentation data. For example, as described with reference to FIG. 2A, the user can select a “more info” user interface element to cause submission of interest data.

Additional offer data are provided to the particular user in response to receipt of the interest data (316). In some implementations, the additional offer data specify how the particular user can purchase the particular product according to the offer. For example, if the offer is being provided by an online advertiser, the additional offer information may provide a link that, upon selection, redirects the user device to a web page associated with the advertiser. If the offer is redeemable at a retail store location, the additional offer information can provide a physical address and/or driving directions to the retail store location at which the particular product is available for purchase according to the offer. The additional offer data can further include a telephone number for the advertiser and/or a map that illustrates a location of the retail store location.

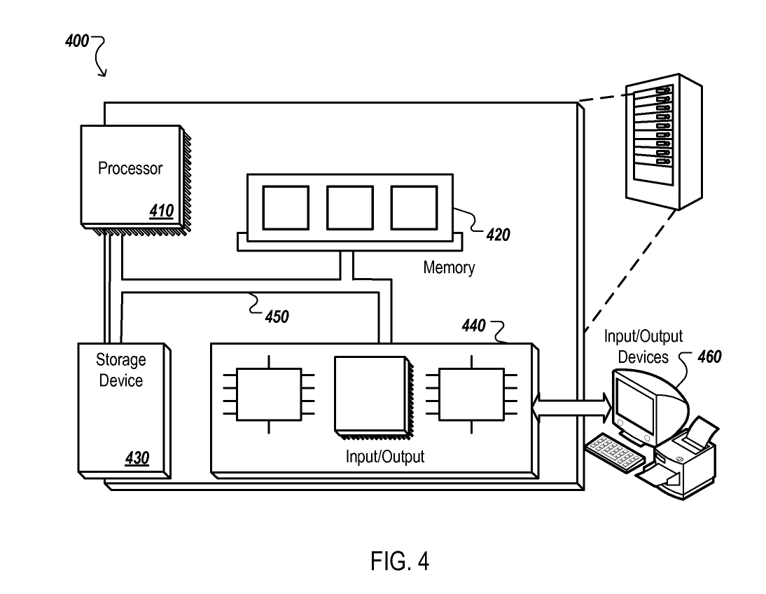

FIG. 4 is block diagram of an example computer system 400 that can be used to facilitate aggregated product requests. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, smartphone device, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

What is claimed is:

1. A method performed by a data processing apparatus, the method comprising:
receiving product request data from a plurality of users, the product request data from each user specifying a particular product and a target price for the particular product;
determining that an offer request condition has occurred, the offer request condition specifying a condition under which offers are requested from advertisers;
in response to determining that the offer request condition has occurred, providing offer request data to advertisers, the offer request data specifying a quantity of users from which product request data specifying the particular product has been received;
receiving offer data from the advertisers, the offer data from each advertiser specifying an offer associated with the particular product and a bid specifying an amount that the advertiser will pay for distribution of the offer to the users from which product request data were received;
selecting an offer to provide to the users in response to receipt of the product request data, the offer being selected using the bids received from the advertisers; and
providing presentation data that cause presentation of the selected offer to at least one of the users from which product request data was received.

2. The method of claim 1, further comprising:
receiving interest data from a particular user, the interest data specifying that the particular user has requested more information about the offer presented by the presentation data; and
in response to receipt of the interest data, providing additional data about the offer to the particular user.

3. The method of claim 2, wherein providing additional data about the offer comprises providing data specifying how the particular user can purchase the particular product according to the offer.

4. The method of claim 3, wherein providing data specifying how the particular user can purchase the particular product according to the offer comprises providing data that cause presentation of a buy interface through which the product is available to be purchased.

5. The method of claim 3, wherein providing additional data about the offer comprises providing data specifying a store location at which the product is available to be purchased.

6. The method of claim 5, wherein providing data specifying a store location comprises redirecting the particular user to web page associated with the advertiser that is associated with the offer.

7. The method of claim 5, wherein providing data specifying a store location comprises providing at least one of a phone number, a map, a physical address or driving directions to a store at which the particular product is available to be purchased according to the offer.

8. The method of claim 1, wherein determining that an offer request condition has occurred comprises determining that product request data associated with the particular product has been received from at least a threshold quantity of users.

9. The method of claim 8, wherein determining that an offer request condition has occurred further comprises determining that at least a threshold time period has elapsed since offer request data was last provided to the advertisers.

10. The method of claim 1, wherein providing offer request data to advertisers comprises:
selecting a set of advertisers that are associated with the particular product;
generating the offer request data to specify at least two of:
a quantity of users from which the request data was received;
a statistical measure of the target prices specified by the request data; and
a user geographic location associated with the users from which the request data was received; and
providing the offer request data to the selected advertisers.

11. The method of claim 10, wherein selecting the set of advertisers comprises selecting a set of advertisers that are associated with a geographic location that is within a threshold distance of the user geographic location.

12. The method of claim 10, wherein the quantity of users from which the request data was received is a quantity of users associated with a pre-specified geographic region.

13. The method of claim 1, wherein receiving offer data from the advertisers comprises receiving, from each advertiser, offer data specifying at least one of a discount at which the advertiser will sell the particular product to the users or a price at which the advertiser will sell the particular product to the users.

14. The method of claim 1, wherein selecting an offer to provide to the users comprises selecting the offer based, at least in part, on a discount value specified by the offer.

15. The method of claim 1, further comprising:
receiving, from at least one user, a request to distribute a message that informs other users of submission of product request data by the at least one user;
generating a message specifying that the at least one user has submitted the product request data; and
distributing the message to other users.

16. A system comprising:
user devices; and
one or more computers operable to interact with the user devices, and to:
receive product request data from the user devices, the product request data from each user device specifying a particular product and a target price for the particular product;
determine that an offer request condition has occurred, the offer request condition specifying a condition under which offers are requested from advertisers;
in response to determining that the offer request condition has occurred, provide offer request data to advertisers, the offer request data specifying a quantity of users from which product request data specifying the particular product has been received;
receive offer data from the advertisers, the offer data from each advertiser specifying an offer associated with the particular product and a bid specifying an amount that the advertiser will pay for distribution of the offer to the users from which product request data were received;
select an offer to provide to the user devices in response to receipt of the product request data, the offer being selected using the bids received from the advertisers; and
provide presentation data that cause presentation of the selected offer to the user devices.

17. The system of claim 16, wherein the one or more computers are further operable to:
receive interest data from at least one of the user devices, the interest data specifying that a particular user has requested more information about the offer presented by the presentation data; and
in response to receiving the interest data, provide additional data about the offer to the at least one user device.

18. The system of claim 17, wherein the one or more computers are further operable to provide data specifying instructions for purchasing the particular product according to the offer.

19. The system of claim 18, wherein the one or more computers are further operable to provide data that cause presentation of a buy interface through which the product is available to be purchased.

20. The system of claim 18, wherein the one or more computers are further operable to provide data specifying a store location at which the product is available to be purchased.

21. The system of claim 20, wherein the one or more computers are further operable to redirect the at least one user device to web page associated with the advertiser that is associated with the offer.

22. The system of claim 20, wherein the one or more computers are further operable to provide at least one of a phone number, a map, a physical address or driving directions to a store at which the particular product is available to be purchased according to the offer.

23. The system of claim 16, wherein the one or more computers are further operable to determine that product request data associated with the particular product has been received from at least a threshold quantity of users.

24. The system of claim 23, wherein the one or more computers are further operable to determine that at least a threshold time period has elapsed since offer request data was last provided to the advertisers.

25. The system of claim 16, wherein the one or more computers are further operable to:
select a set of advertisers that are associated with the particular product;
generate the offer request data to specify at least two of:
a quantity of users from which the request data was received;
a statistical measure of the target prices specified by the request data; and
a user geographic location associated with the users from which the request data was received; and
provide the offer request data to the selected advertisers.

26. The system of claim 25, wherein the set of advertisers comprises a set of advertisers that are associated with a geographic location that is within a threshold distance of the user geographic location.

27. The system of claim 16, wherein the offer data specifies at least one of a discount at which the advertiser will sell the particular product to the users or a price at which the advertiser will sell the particular product to the users.

28. The system of claim 16, wherein the one or more computers are further operable to provide select the offer based, at least in part, on a discount value specified by the offer.

29. The system of claim 16, wherein the one or more computers are further operable to:
receive, from at least one user, a request to distribute a message that informs other users of submission of product request data by the at least one user;
generate a message specifying that the at least one user has submitted the product request data; and
distribute the message to other users.

30. A computer storage medium encoded with a computer program, the program comprising instructions that when executed by data processing apparatus cause the data processing apparatus to perform operations comprising:
receiving product request data from a plurality of users, the product request data from each user specifying a particular product and a target price for the particular product;
determining that an offer request condition has occurred, the offer request condition specifying a condition under which offers are requested from advertisers;
in response to determining that the offer request condition has occurred, providing offer request data to advertisers, the offer request data specifying a quantity of users from which product request data specifying the particular product has been received;
receiving offer data from the advertisers, the offer data from each advertiser specifying an offer associated with the particular product and a bid specifying an amount that the advertiser will pay for distribution of the offer to the users from which product request data were received;
selecting an offer to provide to the users in response to receipt of the product request data, the offer being selected using the bids received from the advertisers; and
providing presentation data that cause presentation of the selected offer to at least one of the users from which product request data was received.
